(19) United States
(12) Patent Application Publication
(10) Pub. No.: US 2018/0295798 A1
(43) Pub. Date: Oct. 18, 2018

(54) Beverage Coaster with Integrated Plant Pot

(71) Applicants: Lyriel J. Jordan, Grandville, MI (US); Marshall E. Poland, Grandville, MI (US)

(72) Inventors: Lyriel J. Jordan, Grandville, MI (US); Marshall E. Poland, Grandville, MI (US)

(21) Appl. No.: 15/936,861

(22) Filed: Mar. 27, 2018

Related U.S. Application Data
(60) Provisional application No. 62/484,896, filed on Apr. 13, 2017.

(51) Int. Cl. A01G 27/02; A47G 23/03

(52) U.S. Cl. CPC A01G 27/02; A01G 9/02; A47G 23/0306

(57) ABSTRACT

A beverage coaster with an integrated plant pot is disclosed, that is configured for watering a plant or plurality of plants with condensation from a beverage container. In an example, the beverage coaster includes a catch basin, and a lattice to support the beverage container above the catch basin, wherein condensation on the beverage container provides water to a reservoir adjacent the catch basin. The reservoir is configured as a plant pot to hold the plant or plurality of plants, and an aperture is provided between the catch basin and reservoir to transport the water that was the condensation from the catch basin to the reservoir for consumption by the plant or plurality of plants.

### CROSS REFERENCE TO RELATED APPLICATIONS

This application claims the priority benefit of U.S. Provisional Patent Application No. 62/484,896 filed Apr. 13, 2017 for “Beverage Coaster With Integrated Plant Pot,” hereby incorporated by reference in its entirety as though fully set forth herein.

### BACKGROUND

Beverage coasters are used to prevent condensation on a beverage container from trickling down onto furniture or other surfaces. Coasters may be made from wood, stone, disposable cardboard, or other materials. With typical beverage coaster designs, condensation water that is formed on the beverage container is either collected on top of, or absorbed by the beverage coaster, and then disposed of or allowed to evaporate.

### BRIEF DESCRIPTION OF THE DRAWINGS

FIG. 1 is a top view of an example beverage coaster with integrated plant pot.

FIG. 2 is a cross section (2-2) view of the example beverage coaster with integrated plant pot.

FIG. 3 is a perspective view of the example beverage coaster with an integrated plant pot.

FIG. 4 is a perspective view of the beverage coaster with an integrated plant pot as it may be implemented with a beverage container.

FIG. 5 is a side view of the example beverage coaster with an integrated plant pot as it may be implemented with a beverage container.

FIG. 6 is a cross section (6-6) view of the example beverage coaster with an integrated plant pot as it may be implemented with a beverage container.

### DETAILED DESCRIPTION

A beverage coaster with integrated plant pot is disclosed which collects condensation water in a vessel (such as an integrated main “cup” area or catch basin), and transports the water into an adjacent vessel (such as an integrated small “cup” area or reservoir). The reservoir can provide a container for living plants. In an example, the beverage coaster includes two circular vessels of varying size that are tangent or adjacent to one another. However, other configurations, numbers, and sizes of vessels may also be provided.

In an example, the catch basin is larger than the reservoir, and is covered with a lattice structure. The lattice structure, also known as the “resting surface”, can support the beverage container, and may include apertures or cut-out shapes which a liquid (e.g., the condensation) can pass through. In an example, the catch basin may include a bottom surface that is sloped (e.g., at a small angle), allowing the liquid to flow downwards. The lowest point of the sloped bottom surface is where the catch basin and reservoir share a tangent wall. At the base of the tangent wall, there is an aperture where water can pass through from the catch basin to the reservoir or plant pot. The reservoir or plant pot may be open on top to enable the plant to be potted therein.

A beverage container may be positioned on or near the first vessel or catch basin, such that condensation from the beverage container is collected as water in the catch basin. When a chilled beverage is placed on the lattice of the beverage coaster, condensation water droplets that form on the outside of the beverage container may drip onto or through the lattice. Water that collects on the lattice may run off due to the hydrophobic properties of the material and/or the geometric shape of the lattice structure, landing in the catch basin. Water that drips directly through openings in the lattice may land directly on the sloped bottom of the catch basin. In any case, water that has dripped onto the smooth, sloped bottom surface of the catch basin flows downward, due to gravity, toward a small aperture in the wall that separates the catch basin portion from the reservoir or plant pot that can hold plants and soil. The water is then transferred from the catch basin to the second vessel (also referred to as the reservoir “plant pot”), where the water can be provided to a plant potted in or near the reservoir.

In an example, the water droplets are absorbed by the soil (or soil-like substance or other growth medium) and/or provide a hydroponic growth area, so that the liquid can be absorbed by the plant roots. Any growth medium and/or fertilizer may also be provided in the reservoir or plant pot. Frequent usage as a beverage coaster (e.g., as determined by the plant species) may supply the plant with adequate water for sustained life, and/or can be supplemented (e.g., by another source of water), if desired.

Before continuing, it is noted that as used herein, the terms “includes” and “including” mean, but are not limited to, “includes” or “including” and “includes at least” or “including at least.” The term “based on” means “based on” and “based at least in part on.”

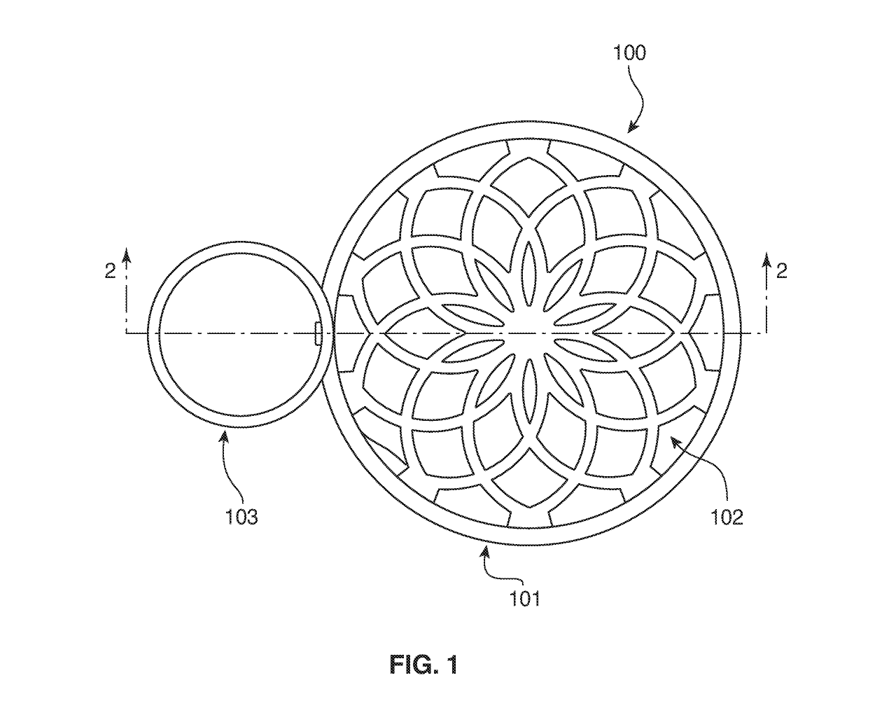

FIG. 1 is a top perspective view of an example of a beverage coaster with integrated plant pot 100. In an example, the beverage coaster with integrated plant pot 100 includes a catch basin 101, a lattice or resting surface 102 over the catch basin 101, and a reservoir 103 which may be implemented as a plant pot. The beverage coaster may be made of any suitable material. By way of illustration, the beverage coaster 100 is made of non-absorbent material(s), such as but not limited to plastic.

The lattice 102 may span all or part of the catch basin 101, and provides a surface and/or support structure for a beverage container to rest on. The structure of the lattice 102 may be chosen to include low points and/or members with a cross section that is narrower and/or rounder on the bottom than on the top, such that water clings less easily to (and thus drains more easily from) the bottom the lattice 102. Similarly, the material of the lattice 102 may be hydrophobic such that water clings to the structure less easily and drains off of the structure more easily.

The example beverage coaster 100 shown in FIG. 1 includes circular “basins” (i.e., the catch basin and the reservoir or plant pot), but any shape can be provided for the catch basin or the reservoir.

The beverage container shown in the drawings may be made of glass and fashioned into a particular size and shape. However, it should be understood that a variety of different beverage containers, made from different materials and in different sizes and shapes, may produce condensation in the same way. As such, it is understood that the beverage coaster with an integrated plant pot 100 disclosed herein may be implemented with any of a wide variety of different beverage containers. It is also understood that more than one reservoir and/or more than a single plant may be implemented with the beverage coaster with an integrated plant pot 100 disclosed herein.

The example structure and operations shown and described herein are provided to illustrate various implementations. It is noted that the components are not limited to the precise arrangement shown in the drawings and/or described above. Still other examples may be implemented that produce the same effect of plant watering via collected condensation from a beverage container.

By way of further illustration, other examples may include, but are not limited to, a removable and replaceable lattice. In another example, the coaster may be customized with different designs. In another example, the sloped floor and/or lattice of the catch basin may be coated with a hydrophobic material to aid in transporting water into the reservoir or plant pot. In another example, the sloped floor may include recessed grooves or channels to aid in consolidating water droplets and transporting the collected water into the reservoir or plant pot, or alternatively to slow transport of the collected water.

By way of further illustration, in addition to, or in place of the aperture 105 between the tangent walls of the two basins (i.e., the catch basin and the reservoir or plant pot), a wicking material and/or porous material can be provided to transfer water between the two basins such as ceramic, fibrous material, or fabric. In this case, the bottom surface does not need to be sloped, although it may be. The plant pot may also be integrated into the catch basin so that the condensation water drips directly onto the soil or roots.

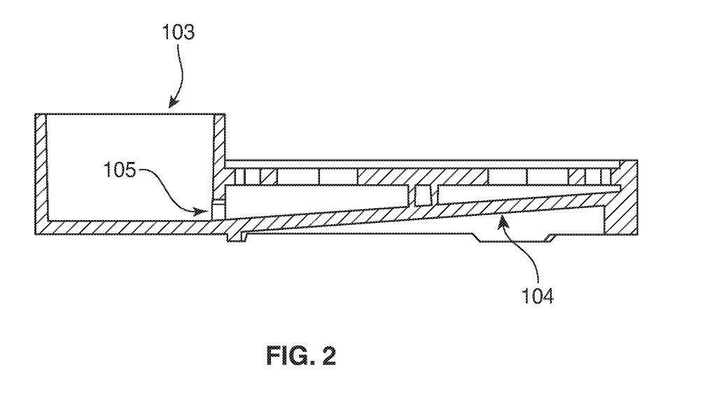

FIG. 2 is a cross section (2-2) view of the example beverage coaster with integrated plant pot 100 as shown in FIG. 1. This view shows the catch basin 101 with lattice structure 102, the sloped bottom surface 104 of the catch basin 101, and the aperture 105 on a tangent wall of the catch basin 101 and the reservoir or plant pot 103. This example configuration permits liquid transport between the catch basin 101 and the reservoir or plant pot 103.

The sloped bottom surface 104 of the catch basin 101 may be constructed from hydrophobic materials to encourage water drainage. In an example, the sloped bottom surface 104 of the catch basin 101 may be sloped at a small angle (e.g., less than about 10 degrees). This slope enables liquid to flow downwards. In another example larger angles may be provided, based on various design considerations. The lowest point of the sloped bottom surface 104 of the catch basin 101 is where the catch basin 101 and plant pot 103 share a tangent wall, where the aperture 105 is located. Water flows along the sloped surface 104 and collects against the tangent wall and/or flows through the aperture 105 into the reservoir or plant pot 103.

In an example, the beverage coaster provides a catch basin and a reservoir (e.g., the plant pot) which are connected and share a tangent wall. However, it is noted that there may be more than one catch basin and/or reservoir. In an example, the catch basin 101 is larger (e.g., about 70 mm to 140 mm in diameter) than the reservoir. In this example, the reservoir or plant pot 103 is smaller (e.g., about 20 mm to 50 mm in diameter). In an example, the catch basin is about 10 mm to 20 mm tall and the reservoir or plant pot is about 15 mm to 40 mm tall. Other dimensions are also contemplated, as will be readily appreciated by those having ordinary skill in the art after becoming familiar with the teachings herein.

In an example, the catch basin 101 has a lattice structure 102 or resting surface with apertures covering the top or opening of the catch basin 101. The lattice structure 102 or resting surface with apertures provides a mechanical structure that can support a liquid-filled beverage container at rest, while at the same time allowing water from the condensation to pass through this surface and into the catch basin 101.

It is noted that the beverage coaster 100 is not limited to a lattice, and other suitable structures (e.g., a plate with openings) may also be provided.

In an example, the catch basin 101 includes a bottom surface 104 which is sloped at a small angle (e.g., less than about 10 degrees) towards the reservoir or plant pot 103. A wall connecting the catch basin 101 and the reservoir or plant pot 103 includes an aperture 105 at the lowest point where the sloped bottom surface contacts the wall. This enables water or liquid from the catch basin 101 to pass through to the reservoir 103. In an example, the aperture is about 4 mm by 7 mm in size and allows for fluid transport between the two basins (i.e., the catch basin and the reservoir or plant pot).

The basins and lattice can be made of plastic, metal, ceramic, treated wood, or other non-absorbent materials, and may be selected for hydrophobic properties to further facilitate transport of the water or liquid into the reservoir 103. Support pillars between the lattice 102 and the sloped bottom surface 104 may also facilitate downward transport of moisture droplets.

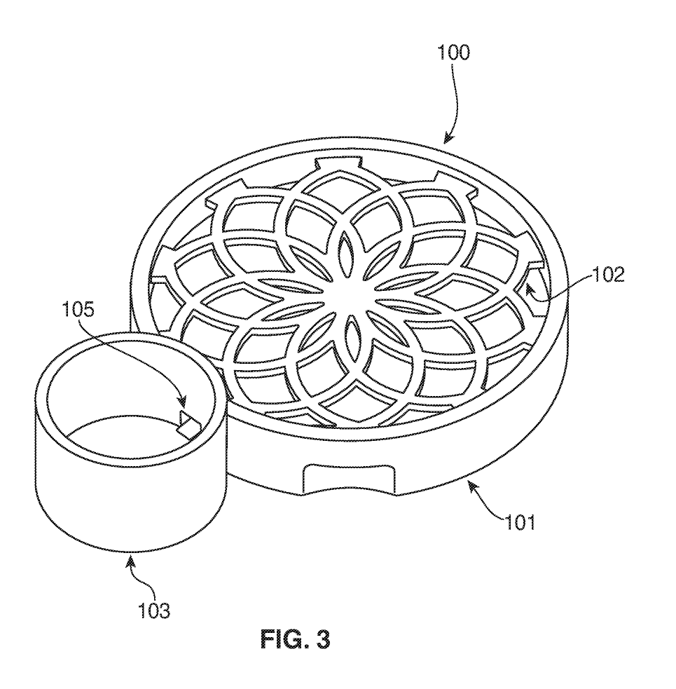

FIG. 3 is a perspective view of a beverage coaster with an integrated plant pot 100. In FIG. 3, the aperture is shown in the tangent wall 105 of the catch basin 101 and the reservoir or plant pot 103.

In an example, the catch basin 101 and the reservoir 103 are circular and of particular relative dimensions, including particular relative diameters, heights, and wall thicknesses. Similarly, the aperture 105 is depicted as being generally rectangular, and of particular size. However, it will be readily appreciated by one having ordinary skill in the art after becoming familiar with the teachings herein, that a variety of different shapes and dimensions may be provided to produce the desired result.

Similarly, the location and/or number of the aperture 105 may be varied to accommodate different basin shapes, without affecting its function, to enable transport of water from the catch basin 101 to the reservoir basin or plant pot 103. The aperture 105 may also be replaced with a plurality of apertures.

Before continuing, it should be noted that the examples described above are provided for purposes of illustration, and are not intended to be limiting. Other devices and/or device configurations may be utilized to carry out the operations described herein.

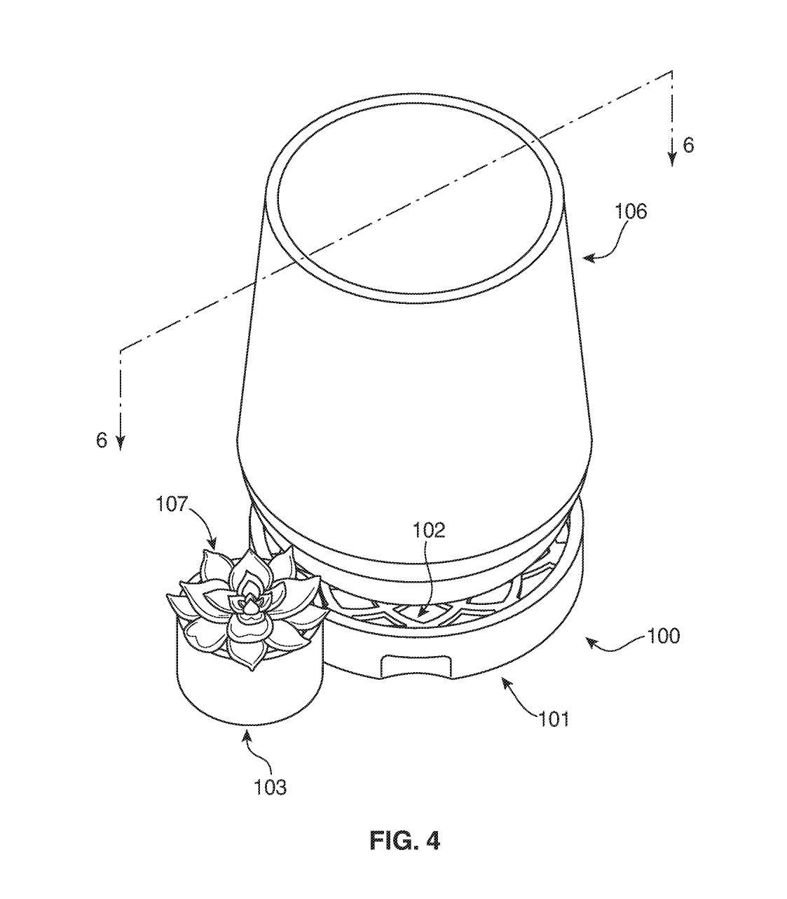

FIG. 4 is a perspective view of an example of the beverage coaster with an integrated plant pot 100. This view shows the beverage coaster with an integrated plant pot 100 of FIGS. 1-3, with a glass beverage container 106 resting on the lattice structure 102 of the catch basin 101. A plant 107 is provided in the reservoir or plant pot 103. In an example, soil or soil-like material (e.g., vermiculite), or other plant growth medium that supports plant growth, may also be provided in the reservoir or plant pot 103.

When a chilled beverage container 106 is placed on the lattice 102 of the beverage coaster 100, condensation may form on the outside of the beverage container 106. This water may drip or otherwise be transported onto the lattice 102, or drip directly onto the sloped bottom 104 of the catch basin 101. Water drops that collect on the lattice 102 may run off due to gravity, and may optionally be assisted by the hydrophobic properties of the material and/or the geometric shape of the lattice structure 102. Water that drips onto the smooth, sloped bottom surface 104 flows downward (due to gravity), towards a small aperture 105 in the tangent wall separating the catch basin 101 and reservoir or plant pot 103. The aperture 105 separates the catch basin 101 and the reservoir 103 that can hold plants and soil. The water that has been transported to the reservoir 103 may be absorbed by the soil or growth medium and can be absorbed by plant roots. Frequent usage of the beverage coaster 100 (e.g., determined by the plant species) can supply some or all of the plants' water needs.

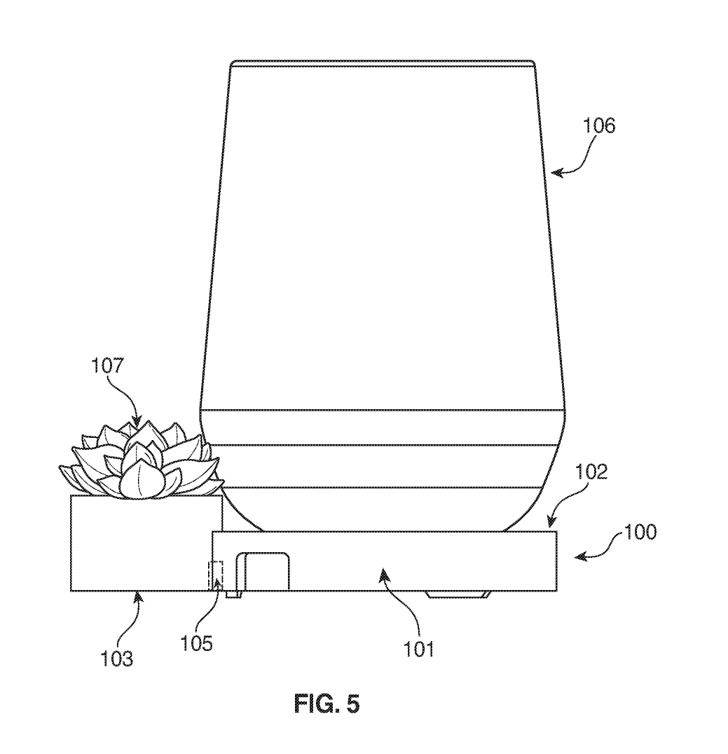

FIG. 5 is a side view of the example beverage coaster with an integrated plant pot 100 as it may be implemented with a beverage container 106. In this view it can be seen that the condensation from the example beverage container 106 drips down to the sloped bottom of the catch basin 101, where the sloped bottom carries the water to an aperture 105 that passes into the reservoir or plant pot 103, where the water may be absorbed by soil or other growth medium to nourish plants.

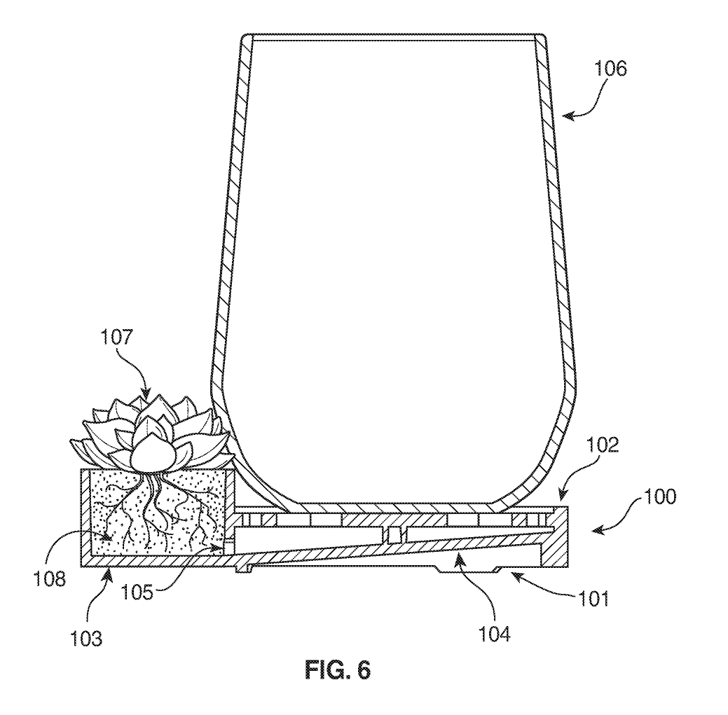

FIG. 6 is a cross section (6-6) view of the example beverage coaster with an integrated plant pot 100, as it may be implemented with a beverage container 106. In this view it can be seen that the soil or growth medium 108, and the plant or plants 107 situated upon or within the reservoir or plant pot 103 receives condensation from the beverage container 106. That is, the water from the condensation drips through (or drips onto and off of) the lattice 102, onto to the sloped surface 104 of the catch basin 101, and moves to the aperture 105 and through the aperture 105 into the reservoir or plant pot 103. Water reaching the reservoir 103 may be absorbed by the soil or growth medium 108 to support the growth of a plant or plants 107.

It is noted that the examples shown and described are provided for purposes of illustration and are not intended to be limiting. Still other examples are also contemplated.

1. A method of watering a plant or plurality of plants with condensation from a beverage container, comprising:
collecting moisture from condensation on a beverage container in a catch basin; and
transporting the collected moisture from the catch basin to a reservoir;
wherein moisture that was condensation on the beverage container is provided to the plant or plurality of plants in or near the reservoir to supply some or all of the plant or plurality of plants water needs.

2. The method of claim 1, further comprising supporting the beverage container above the catch basin while providing drainage of the collected moisture into the catch basin.

3. The method of claim 2, further comprising discouraging adhesion of the collected moisture and promote flow of the water in the catch basin to the reservoir.

4. The method of claim 1, further comprising providing a sloped surface and an aperture to transport the collected moisture to the reservoir.

5. The method of claim 1, further comprising wicking the collected moisture between the catch basin and the reservoir.

6. The method of claim 1, further comprising promoting flow of the collected moisture by at least one of hydrophobic material and hydrophobic coating, to enhance transport of the collected moisture to the reservoir.

7. A beverage coaster with an integrated plant pot configured for watering a plant or plurality of plants with condensation from a beverage container, comprising:
a catch basin;
a lattice to support the beverage container above the catch basin, wherein condensation on the beverage container provides water;
a reservoir adjacent the catch basin, the reservoir configured as a plant pot to hold the plant or plurality of plants; and
an aperture between the catch basin and reservoir to transport the water that was the condensation from the catch basin to the reservoir for the plant or plurality of plants.

8. The device of claim 7, further comprising a transport surface in the catch basin to facilitate transport of the water that was the condensation.

9. The device of claim 8, wherein the transport surface of the catch basin is sloped to facilitate transport of the water that was the condensation toward the reservoir via gravity.

10. The device of claim 8, wherein the transport surface of the catch basin has a hydrophobic surface to promote flow and discourage clinging of the water that was the condensation in the catch basin.

11. The device of claim 8, wherein the transport surface of the catch basin includes at least one of slots, grooves, and channels to direct the water that was the condensation toward the reservoir.

12. The device of claim 7, further comprising a wicking material between the catch basin and the reservoir.

13. The device of claim 7, wherein the lattice includes members with a cross section that is at least one of narrower and rounder on a bottom side of the lattice to discourage clinging of water to the lattice.

14. The device of claim 7, wherein the lattice includes has at least one of low points and pillars to discourage clinging of water to the lattice.

15. A beverage coaster that provides water from condensation on a beverage container for at least one plant, comprising:
a resting surface on which the beverage container may be placed;
at least one opening formed in the resting surface to enable water that was the condensation on the beverage container to travel through the resting surface;
a catch basin beneath the resting surface, the catch basin receiving the water that was the condensation on the beverage container; and
a reservoir configured as a plant pot for the at least one plant, the reservoir receiving the water that was the condensation on the beverage container from the catch basin.

16. The device of claim 15, wherein the catch basin incorporates at least one of hydrophobic materials and a slope to facilitate collection of the water that was the condensation on the beverage container.

17. The device of claim 15, wherein the catch basin incorporates relief features to facilitate collection of the water that was the condensation on the beverage container.

18. The device of claim 15, further comprising at least one of a wick and an aperture to enable transport of the water that was the condensation on the beverage container from the catch basin to the reservoir.

19. The device of claim 15, wherein the resting surface incorporates hydrophobic materials to facilitate movement of the water that was the condensation on the beverage container into the catch basin.

20. The device of claim 15, wherein the resting surface has a shape to facilitate the movement of the water that was the condensation on the beverage container.
